(19) United States
(12) Patent Application Publication
(10) Pub. No.: US 2026/0017403 A1
(43) Pub. Date: Jan. 15, 2026

(54) IMAGING APPARATUS AND DATA OUTPUT METHOD

(71) Applicant: Sony Semiconductor Solutions Corporation, Kanagawa (JP)

(72) Inventors: Akito KUWABARA, Kanagawa (JP); Masanobu OKABE, Kanagawa (JP); Hiroyuki OZAWA, Kanagawa (JP)

(73) Assignee: Sony Semiconductor Solutions Corporation, Kanagawa (JP)

(21) Appl. No.: 18/880,967

(22) PCT Filed: Jun. 27, 2023
(86) PCT No.: PCT/JP2023/023702

§ 371 Date: Jan. 3, 2025

(30) Foreign Application Priority Data
Jul. 11, 2022 (JP) 2022-111008

(51) Int. Cl. G06F 21/62; G06V 10/82; G06V 20/52

(52) U.S. Cl. CPC G06F 21/6245; G06V 10/82; G06V 20/52

(57) ABSTRACT

The present disclosure relates to an imaging apparatus and a data output method capable of reducing the risk of privacy invasion.

An imaging unit, in which a plurality of pixels are two-dimensionally aligned, configured to capture an image, a signal processing unit configured to execute signal processing for image data based on an output of the imaging unit, an output unit, which is not directly connected to the imaging unit, configured to be able to output only a signal processing result of the signal processing to the outside are included, and the signal processing unit deletes the image data after the signal processing. The present disclosure can be applied to an image sensor in which an AI function is mounted.

### TECHNICAL FIELD

The present disclosure relates to an imaging apparatus and a data output method, and more particularly, to an imaging apparatus and a data output method capable of reducing the risk of privacy invasion.

### BACKGROUND ART

In PTL 1, an image sensor in which an imaging unit imaging an image and a signal processing unit executing signal processing on image data based on an output of the imaging unit are arranged in a single chip is disclosed. The image sensor disclosed in PTL 1 is configured to selectively output at least one of a signal processing result of signal processing, intermediate data acquired during the signal processing, and image data to the outside.

### Citation List

### Patent Literature

[PTL 1]
WO 2018/051809

### SUMMARY

### Technical Problem

According to the image sensor of PTL 1, only a signal processing result can be output to the outside, and thus there is an advantage from the point of view of privacy protection. However, since it is not the case that image data cannot be output, there is a risk of privacy invasion.

The present disclosure is in view of such situations and is capable of reducing the risk of privacy invasion.

### Solution to Problem

An imaging apparatus according to a first aspect of the present disclosure is an imaging apparatus including: an imaging unit, in which a plurality of pixels are two-dimensionally aligned, configured to capture an image; a signal processing unit configured to execute signal processing for image data based on an output of the imaging unit; and an output unit, which is not directly connected to the imaging unit, configured to be able to output only a signal processing result of the signal processing to the outside, wherein the signal processing unit deletes the image data after the signal processing.

An imaging apparatus according to a second aspect of the present disclosure is an imaging apparatus including: an imaging unit, in which a plurality of pixels are two-dimensionally aligned, configured to capture an image; a signal processing unit configured to execute signal processing for image data based on an output of the imaging unit; an output unit configured to be able to output a signal processing result of the signal processing to the outside; and a checking processing unit configured to execute a checking process of checking that the image data is not included in an output of the signal processing unit before the signal processing.

A data output method according to a first aspect of the present disclosure is a data output method including deleting image data after signal processing using an imaging apparatus including: an imaging unit, in which a plurality of pixels are two-dimensionally aligned, configured to capture an image; a signal processing unit configured to execute the signal processing for the image data based on an output of the imaging unit; and an output unit, which is not directly connected to the imaging unit, configured to be able to output only a signal processing result of the signal processing to the outside.

In the first aspect of the present disclosure, in an imaging apparatus including: an imaging unit, in which a plurality of pixels are two-dimensionally aligned, configured to capture an image; a signal processing unit configured to execute signal processing for image data based on an output of the imaging unit; and an output unit, which is not directly connected to the imaging unit, configured to be able to output only a signal processing result of the signal processing to the outside, the image data is deleted after the signal processing.

In the second aspect of the present disclosure, in an imaging apparatus including: an imaging unit, in which a plurality of pixels are two-dimensionally aligned, configured to capture an image; a signal processing unit configured to execute signal processing for image data based on an output of the imaging unit; and an output unit configured to be able to output a signal processing result of the signal processing to the outside, a checking process of checking that the image data is not included in the output of the signal processing unit is executed before the signal processing.

### BRIEF DESCRIPTION OF DRAWINGS

FIG. 1 is a block diagram illustrating a configuration example of a conventional imaging apparatus.

FIG. 2 is a block diagram illustrating a configuration example of an imaging apparatus to which a technology according to the present disclosure is applied.

FIG. 3 is a perspective view illustrating an overview of an external configuration example of an imaging apparatus.

FIG. 4 is a block diagram illustrating a configuration example of an imaging apparatus according to a first embodiment.

FIG. 5 is a diagram illustrating an example of access restrictions for a work memory.

FIG. 6 is a flowchart for describing an operation of a DSP.

FIG. 7 is a block diagram illustrating a first configuration example of an imaging apparatus according to a second embodiment.

FIG. 8 is a flowchart for describing an operation of a network inspection block.

FIG. 9 is a diagram for describing checking of a network structure.

FIG. 10 is a flowchart for describing an operation of an entire imaging apparatus.

FIG. 11 is a block diagram illustrating a second configuration example of an imaging apparatus according to a second embodiment.

FIG. 12 is a flowchart for describing an operation of a checking-dedicated processor.

FIG. 13 is a block diagram illustrating a third configuration example of an imaging apparatus according to the second embodiment.

FIG. 14 is a flowchart for describing an operation of a checking-dedicated processor.

FIG. 15 is a diagram for describing an application example of a technology according to the present disclosure.

FIG. 16 is a diagram for describing an application example of a technology according to the present disclosure.

### DESCRIPTION OF EMBODIMENTS

Hereinafter, modes for carrying out the present disclosure (hereinafter referred as embodiments) will be described. Note that the description will be presented in the following order.
1. Problems of Conventional Technology and Overview of Technology Relating to Present Disclosure
2. First Embodiment (image data is deleted after recognition process)
3. Second Embodiment (checking that image data is not included in output of recognition processing unit)
4. Application Example

### 1. Problems of Conventional Technology and Overview of Technology Relating to Present Disclosure

### (Conventional Imaging Apparatus)

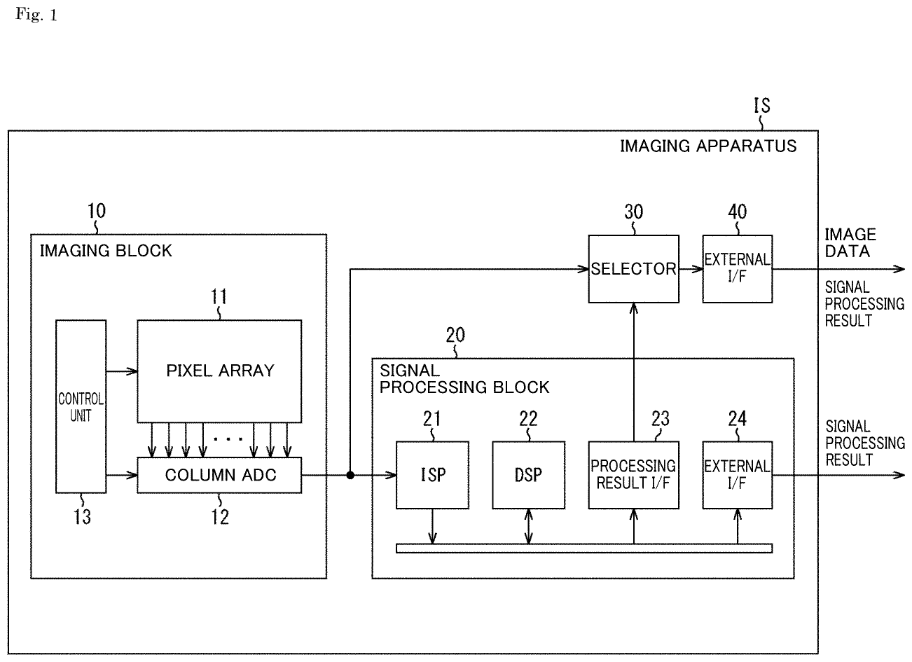

FIG. 1 is a block diagram illustrating a configuration example of a conventional imaging apparatus.

An imaging apparatus IS illustrated in FIG. 1, for example, is a complementary metal oxide semiconductor (CMOS) image sensor configured using one chip, receives incident light from an optical system not illustrated in the drawing, performs photoelectric conversion, and outputs image data corresponding to the incident light from the optical system.

In addition, the imaging apparatus IS, for example, performs signal processing such as recognition processing of recognizing a predetermined recognition target and the like using output image data and the like and outputs a signal processing result of the signal processing.

As illustrated in FIG. 1, the imaging apparatus IS includes an imaging block 10, a signal processing block 20, a selector 30, and an external I/F 40. The imaging block 10 and the signal processing block 20 are electrically connected using connection lines, as are the signal processing block 20 and the selector 30. In addition, the imaging block 10 and the selector 30 are directly electrically connected using a connection line.

The imaging block 10 includes a pixel array 11, a column analog to digital converter (ADC) 12, and a control unit 13.

The pixel array 11 is configured as an imaging unit in which a plurality of pixels is two-dimensionally aligned. The pixel array 11 is driven by the control unit 13 to capture an image. More specifically, the pixel array 11 in each pixel receives incident light from an optical system not illustrated in the drawing, performs photoelectric conversion, and outputs an analog image signal corresponding to the incident light.

The column ADC 12 reads an analog image signal output by the pixel array 11 and performs AD conversion in accordance with control of the control unit 13. The column ADC 12 outputs a digital image signal acquired by performing AD conversion of an analog image signal as image data (raw data).

The raw data output by the column ADC 12 is supplied to the signal processing block 20 and is supplied to the selector 30.

The control unit 13 controls operations of the pixel array 11 and the column ADC 12. More specifically, the control unit 13 controls driving of each pixel of the pixel array 11 and reading and AD conversion of an image signal using the column ADC 12.

The signal processing block 20 includes an image signal processing (ISP) unit 21, a digital signal processor (DSP) 22, a processing result I/F 23, and an external I/F 24.

The units configuring the signal processing blocks 20 are interconnected through a bus and can exchange information as necessary.

Although not illustrated in the drawing, a central processing unit (CPU) performing various processes starting from control of the entire signal processing block 20 by executing a program stored in a memory not illustrated in the drawing is disposed in the signal processing block 20.

The ISP unit 21 performs various kinds of image processing on image data (raw data) from the imaging block 10. For example, the ISP unit performs a high dynamic range (HDR) conversion process, defect correction, development processing, and the like on image data from the imaging block 10.

The DSP 22 functions as a signal processing unit that performs signal processing using image data after image processing performed by the ISP unit 21.

The processing result I/F 23 supplies a signal processing result of signal processing using image data that is performed by the DSP 22 and a result acquired by performing various kinds of image processing on image data that is performed by the ISP unit 21 to the selector 30.

The external I/F 24 outputs a signal processing result of signal processing using image data that is performed by the DSP 22 to the outside. The external I/F 24, for example, is configured using a serial communication I/F such as a serial peripheral interface (SPI) or the like.

The selector 30 performs output control of selectively outputting image data (raw data) from the imaging block 10 and a signal processing result of signal processing from the signal processing block 20 from the external I/F 40 to the outside. In other words, the selector 30 selects the image data from the imaging block 10, the signal processing result from the signal processing block 20, or both thereof and supplies them to the external I/F 40.

Intermediate data acquired during signal processing using image data that is performed by the DSP 22 may be supplied to the selector 30 through the processing result I/F 23. In this case, the selector 30 performs output control of selectively outputting any one of both image data from the imaging block 10 and a signal processing result from the signal processing block 20 and intermediate data acquired during signal processing from the external I/F 40 to the outside. In a case in which intermediate data acquired during signal processing (for example, recognition processing) is output from the external I/F 40 to the outside, the intermediate data can be provided for a debugger of a program used for performing the signal processing.

The external I/F 40 is an I/F that outputs image data and a signal processing result supplied from the selector 30 to the outside. As the external I/F 40, for example, a parallel communication I/F having a relatively high speed such as a mobile industry processor interface (MIPI) can be employed.

In the external I/F 40, in accordance with output control of the selector 30, image data from the imaging block 10 or a signal processing result according to the DSP 22 from the signal processing block 20 is output to the outside. Thus, for example, in a case in which only a signal processing result according to the DSP 22 from the signal processing block 20 is necessary, and image data (a captured image) is not necessary outside, only the signal processing result can be output, and thus the amount of data output from the external I/F 40 to the outside can be reduced. In addition, in a case in which image data (a captured image) is not necessary, only a signal processing result according to the DSP 22 from the signal processing block 20 can be output to the outside also from the external I/F 24.

In this way, according to the imaging apparatus IS, only a signal processing result can be output to the outside, and thus it can be regarded that there is an advantage from the point of view of privacy protection. However, because it is not impossible to output image data, there is a risk of privacy invasion.

(Imaging Apparatus to which Technology According to Present Disclosure is Applied)

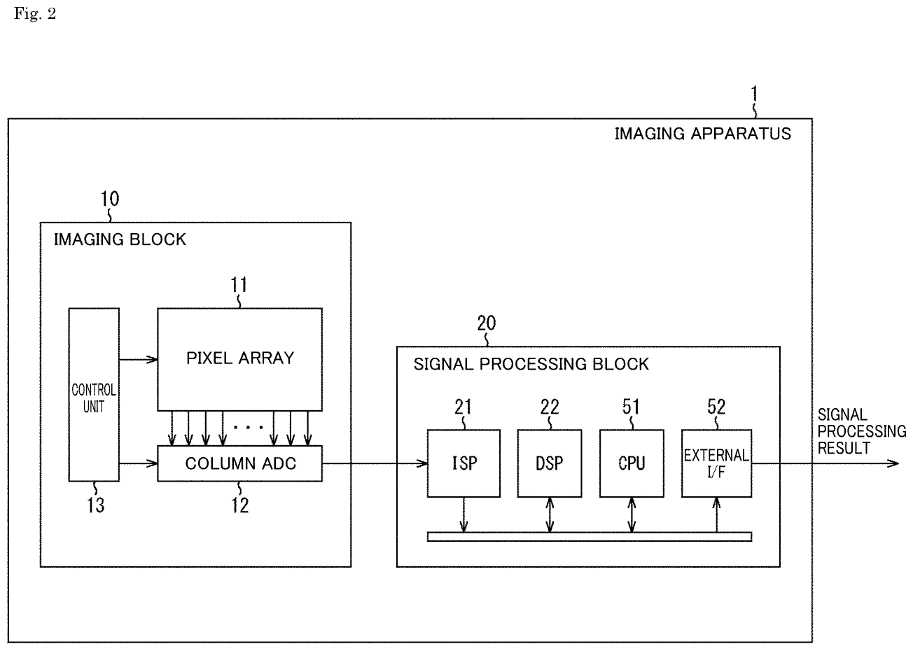

FIG. 2 is a block diagram illustrating a configuration example of an imaging apparatus to which a technology according to the present disclosure is applied.

Also the imaging apparatus 1 illustrated in FIG. 2 is, for example, a CMOS image sensor configured using one chip and receives incident light from an optical system not illustrated in the drawing, performs photoelectric conversion, and outputs image data corresponding to the incident light from the optical system.

In addition, the imaging apparatus 1 performs signal processing, for example, such as recognition processing of recognizing a predetermined recognition target using output image data and the like and outputs a signal processing result of the signal processing.

As illustrated in FIG. 2, the imaging apparatus 1 includes an imaging block 10 and a signal processing block 20. In the imaging apparatus 1, the same reference signs will be assigned to the same components as the components included in the imaging apparatus IS illustrated in FIG. 1, and description thereof will be appropriately omitted.

The imaging apparatus 1 illustrated in FIG. 2 is different from the imaging apparatus IS illustrated in FIG. 1 in that it does not include the selector 30 or the external I/F 40. In other words, the imaging apparatus 1 illustrated in FIG. 2 does not have an external I/F that is directly connected to the pixel array 11 (the imaging block 10) as an imaging unit.

In addition, the imaging apparatus 1 illustrated in FIG. 2 is different from the imaging apparatus IS illustrated in FIG. 1 in that it includes a CPU 51 and an external I/F 52 inside of the signal processing block 20 in place of the processing result I/F 23 and the external I/F 24.

By executing a program stored in a memory not illustrated in the drawing, the CPU 51 performs various processes starting from control of the entire signal processing block 20.

Similar to the external I/F 24 illustrated in FIG. 1, the external I/F 52 outputs a signal processing result of signal processing on image data according to the DSP 22 to the outside. Here, the external I/F 52 is not limited to a serial communication I/F such as an SPI and may be configured using a parallel communication I/F such as an MIPI or any other communication I/F.

In other words, the external I/F 52 is configured as an output unit, which is capable of outputting only a signal processing result of signal processing to the outside, and is not directly connected to the pixel array 11 (the imaging block 10) as an imaging unit.

Furthermore, the imaging apparatus 1 can employ a configuration in which the DSP 22 deletes image data after signal processing or a configuration in which the CPU 51 checks that image data is not included in an output of the DSP 22 before signal processing.

In accordance with this, the imaging apparatus 1 can realize a configuration in which image data cannot be output to the outside.

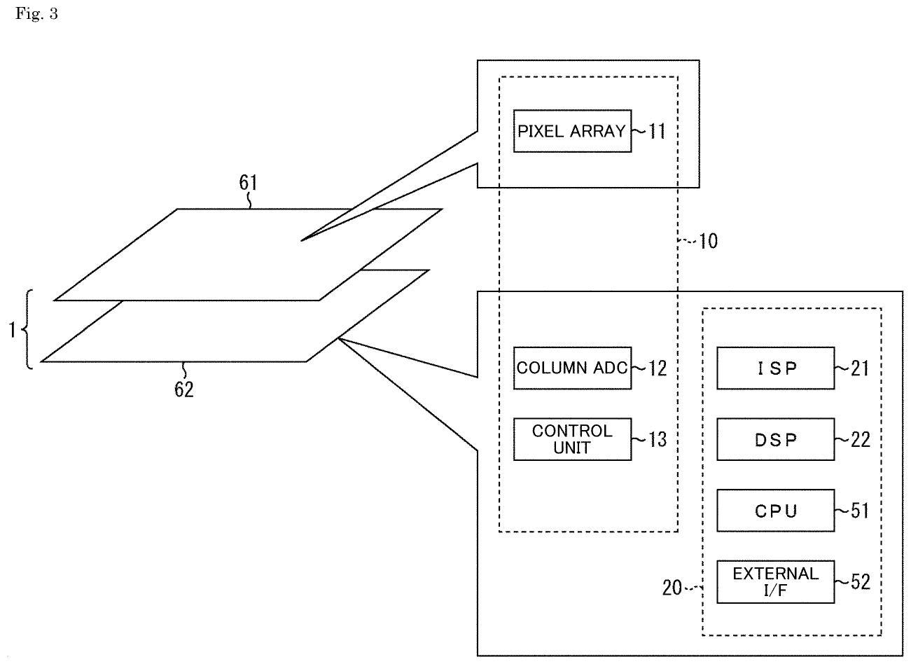

FIG. 3 is a perspective view illustrating an overview of an external configuration example of the imaging apparatus 1 illustrated in FIG. 2.

The imaging apparatus 1, for example, can be configured as a one-chip semiconductor device having a stacking structure in which a plurality of dies is stacked.

More specifically, as illustrated in FIG. 3, the imaging apparatus 1 is configured by stacking two dies including a die 61 and a die 62.

In FIG. 3, a pixel array 11 is mounted in the die 61 of the upper side, and a column ADC 12, a control unit 13, an ISP unit 21, a DSP 22, a CPU 51, and an external I/F 52 are mounted in the die 62 of the lower side.

The die 61 of the upper side and the die 62 of the lower side are electrically connected, for example, by forming a through hole that passes through the die 61 and reaches the die 62, by performing Cu—Cu bonding directly connecting a Cu wiring exposed to the lower-face side of the die 61 and a Cu wiring exposed to the upper-face side of the die 62, or the like.

Here, as a system for performing AD conversion of an image signal output by the pixel array 11, the column ADC 12, for example, can employ a column-parallel AD system or an area AD system.

As the column-parallel AD system, for example, an ADC is disposed for each column of pixels configuring the pixel array 11, and the ADC of each column is responsible for AD conversion of pixel signals of pixels of the column, whereby AD conversion of image signals of pixels of each column of one row is performed in parallel. In a case in which the column-parallel AD system is employed, some of column ADCs 12 performing AD conversion of the column-parallel AD system may be mounted in the die 61 of the upper side.

In the area AD system, pixels configuring the pixel array 11 are divided into a plurality of blocks, and an ADC is disposed for each block. The ADC of each block is responsible for AD conversion of pixel signals of pixels of the block, and thus AD conversion of image signals of pixels of a plurality of blocks is performed in parallel. In the area AD system, AD conversion (readout and AD conversion) of image signals can be performed only for necessary pixels among pixels configuring the pixel array 11 using a block as a minimal unit.

In addition, when the area of the imaging apparatus 1 is allowed to be increased, the imaging apparatus 1 can be configured using one die.

In addition, in the example illustrated in FIG. 3, although the imaging apparatus 1 of one chip is configured by stacking two dies 61 and 62, the imaging apparatus 1 of one chip can be configured by stacking three or more dies.

As signal processing performed by the imaging apparatus 1, that is, signal processing of the DSP 22, for example, recognition processing of recognizing a predetermined recognition target from image data can be employed.

In addition, the imaging apparatus 1 can receive an output of a distance sensor such as a ToF (Time of Flight) sensor arranged to have a predetermined positional relation with the imaging apparatus 1 using the external I/F 52. In this case, as the signal processing of the DSP 22, for example, a fusion process acquiring a distance having high accuracy by integrating an output of a distance sensor and a captured image such as a process of eliminating noise of a distance image acquired from the output of the distance sensor received from the external I/F 52 using a captured image can be employed.

In addition, the imaging apparatus 1 can receive an image output by another image sensor arranged to have a predetermined positional relation with the imaging apparatus 1 using the external I/F 52. In this case, as the signal processing of the DSP 22, for example, a self-position estimating process (SLAM (Simultaneously Localization and Mapping)) in which an image received by the external I/F 52 and an image captured by the imaging apparatus 1 are used as a stereo image can be employed.

Hereinafter, an embodiment of an imaging apparatus (image sensor) configured to execute recognition processing as signal processing of the DSP 22 will be described.

### 2. First Embodiment

### (Configuration Example of Imaging Apparatus)

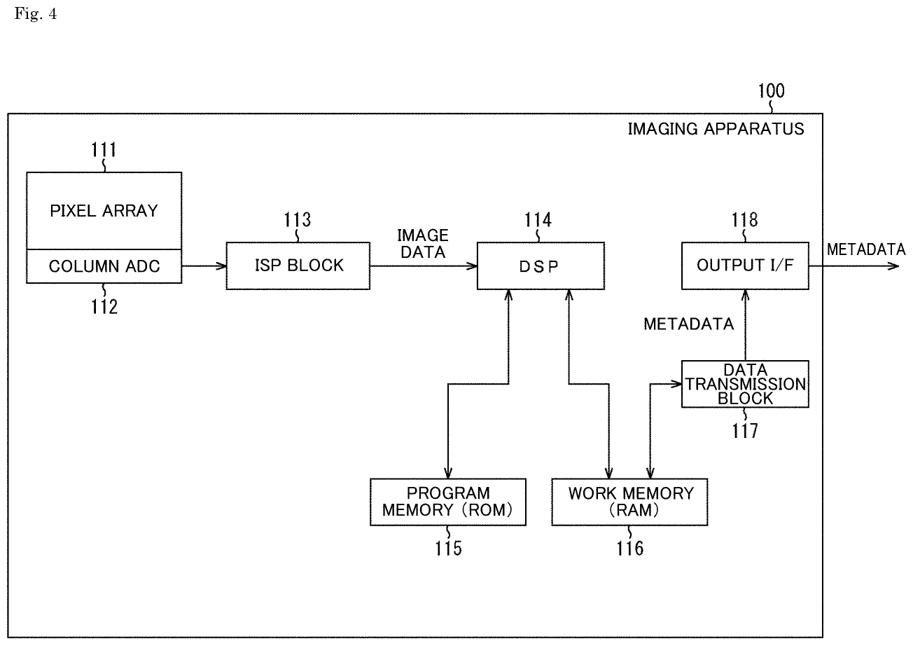

FIG. 4 is a block diagram illustrating a configuration example of an imaging apparatus according to a first embodiment.

The imaging apparatus 100 illustrated in FIG. 4 includes a pixel array 111, a column ADC 112, an ISP block 113, a DSP 114, a program memory 115, a work memory 116, a data transmission block 117, and an output I/F 118.

The pixel array 111, the column ADC 112, and the ISP block 113 have functions respectively similar to the pixel array 11, the column ADC 12, and the ISP unit 21 included in the imaging apparatus 1 illustrated in FIG. 2, and thus description thereof will be omitted.

The DSP 114 executes recognition processing recognizing a predetermined recognition target for image data as signal processing using image data after image processing according to the ISP block 113.

In the program memory 115, a program for the DSP 114 to execute recognition processing is stored. The program memory 115 is configured using a ROM (Read Only Memory) and causes the program for executing the recognition processing to be un-rewritable. This program is configured as a program in which processing details causing signal processing using a neural network, for example, recognition processing using a DNN to be executable are described.

In other words, the DSP 114 can execute recognition processing using a DNN in accordance with a program stored in the program memory 115.

The work memory 116 is configured using a RAM (Random Access Memory) and temporarily stores data relating to the recognition processing executed by the DSP 114. More specifically, in the work memory 116, image data used in recognition processing and metadata of image data output as a recognition result of recognition processing are written by the DSP 114. In addition, after the recognition processing using the DSP 114, image data written into the work memory 116 is deleted by the DSP 114.

The data transmission block 117, for example, is configured using a DMA (Direct Memory Access) controller and controls transmission of data from the work memory 116 to the output I/F 118. More specifically, the data transmission block 117 transmits only metadata (a recognition result) written into the work memory 116 to the output I/F 118.

The output I/F 118 has a function similar to the external I/F 52 included in the imaging apparatus 1 illustrated in FIG. 2 and is configured as an output unit, which is not directly connected to the pixel array 11, that can output metadata (a recognition result) to the outside

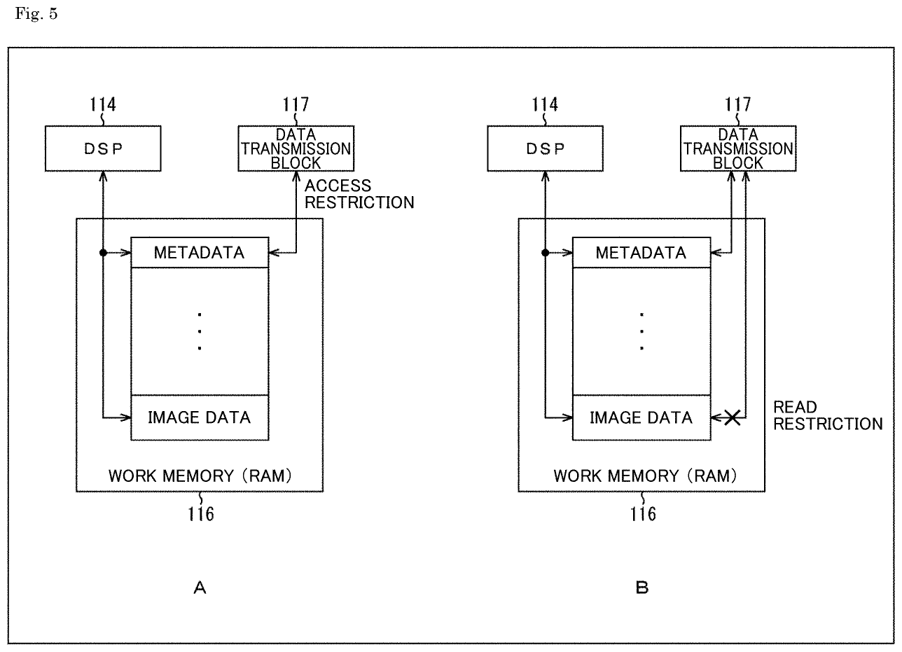

FIG. 5 is a diagram illustrating an example of access restrictions for the work memory 116 of the data transmission block 117.

As illustrated in A of FIG. 5, an access restriction that an access can be made only to a storage area in which metadata (a recognition result) is written among storage areas of the work memory 116 may be applied to the data transmission block 117.

In addition, as illustrated in B of the diagram, a read restriction that data cannot be read from a storage area in which image data is written among storage areas of the work memory 116 may be applied to the data transmission block 117.

In accordance with the access restriction and the read restriction, even in a case in which image data written in the work memory 116 has not been deleted due to a certain reason, a configuration in which only metadata (a recognition result) can be output to the outside can be realized more reliably.

### (Operation of DSP)

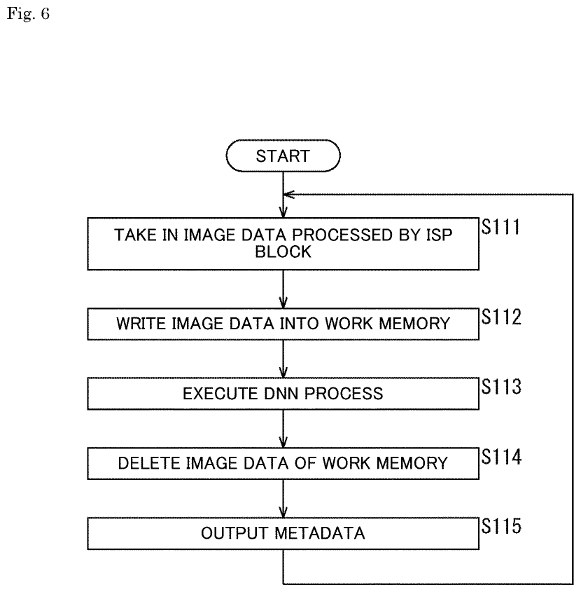

An operation of the DSP 114 will be described with reference to a flowchart illustrated in FIG. 6. The process of FIG. 6 is repeated for each frame of an image captured by the pixel array 111.

In Step S111, the DSP 114 takes in image data processed by the ISP block 113.

In Step S112, the DSP 114 writes the image data that has been taken in into the work memory 116.

In Step S113, the DSP 114 executes a DNN process (recognition processing using a DNN) on image data written in the work memory 116.

In Step S114, the DSP 114 deletes the image data written in the work memory 116.

In Step S115, the DSP 114 outputs metadata that is a recognition result of the recognition processing to the work memory 116.

In accordance with the configuration and the process described above, although image data is written into the work memory 116 once for recognition processing, it is deleted after the recognition processing, and only metadata (a recognition result) is output to the outside. As a result, image data is not output to the outside, and the risk of privacy invasion can be reduced.

In addition, since a program for executing recognition processing is configured to be un-rewritable, a structure in which image data is not output to the outside can be reliably realized.

### 3. Second Embodiment

In this embodiment, a configuration in which it is checked that image data is not included in an output of the DSP that is a recognition processing unit will be described.

### First Configuration Example

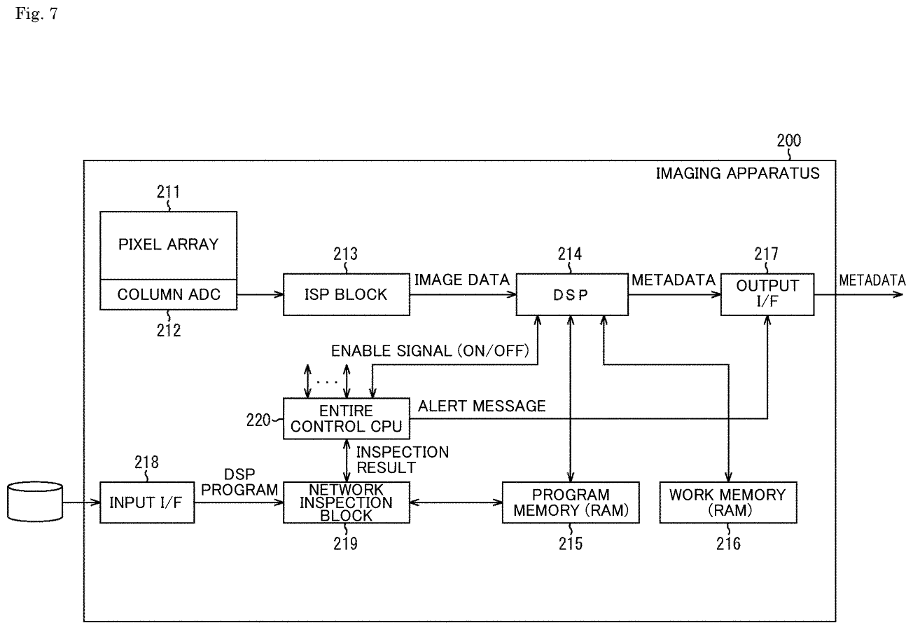

FIG. 7 is a block diagram illustrating a first configuration example of an imaging apparatus according to a second embodiment.

The imaging apparatus 200 illustrated in FIG. 7 includes a pixel array 211, a column ADC 212, an ISP block 213, a DSP 214, a program memory 215, a work memory 216, and an output I/F 217. Such components basically have functions similar to the pixel array 111, the column ADC 112, the ISP block 113, the DSP 114, the program memory 115, the work memory 116, and the output I/F 118 included in the imaging apparatus illustrated in FIG. 4, and thus description thereof will be omitted.

However, differently from the DSP 114 illustrated in FIG. 4, the DSP 214 directly outputs metadata as a recognition result of recognition processing to the output I/F 217 instead of writing the metadata into the work memory 216.

In addition, the data transmission block 117 illustrated in FIG. 4 may be disposed in the imaging apparatus 200. In this case, the DSP 214 may write metadata as a recognition result of recognition processing into the work memory 216, and the data transmission block 117 may transmit the metadata written in the work memory 216 to the output I/F 217.

In addition, differently from the program memory 115 illustrated in FIG. 4, the program memory 215 is configured using not a ROM but a RAM, and a program for executing recognition processing that is loaded from the outside is written into the program memory 215.

The imaging apparatus 200 further includes an input I/F 218, a network inspection block 219, and an entire control CPU 220.

The input I/F 218 receives an input of a program (hereinafter, also referred to as a DSP program), in which an AI model and the like are operating in the DSP 214, provided by a user of the imaging apparatus 200. Also this DSP program is regarded to be a program in which processing details causing signal processing using a neural network, for example, recognition processing using a DNN to be executable are described.

The network inspection block 219 is configured using a predetermined processor or is realized using predetermined software and has a function of a checking processing unit executing a checking process of checking that image data is not included in an output of the DSP 214 before recognition processing using the DSP 214.

More specifically, the network inspection block 219 loads a DSP program from the outside through the input I/F 218 and writes the DSP program into the program memory 215. The network inspection block 219 executes the checking process described above for the DSP program that has been written into the program memory 215. In more details, the network inspection block 219 checks that image data is not included in the output of the DSP 214 by inspecting that the network structure of the neural network (DNN) is a structure that is unable to output image data and outputs an inspection result thereof to the entire control CPU 220.

The entire control CPU 220 executes a program stored in a memory not illustrated in the drawing, thereby performing various processes starting from control of the entire imaging apparatus 200. For example, the entire control CPU 220 controls execution of recognition processing using the DSP 214 on the basis of an inspection result from the network inspection block 219. In addition, the entire control CPU 220 functions as an alert generating unit generating alert information on the basis of the inspection result from the network inspection block 219.

### (Operation of Network Inspection Block)

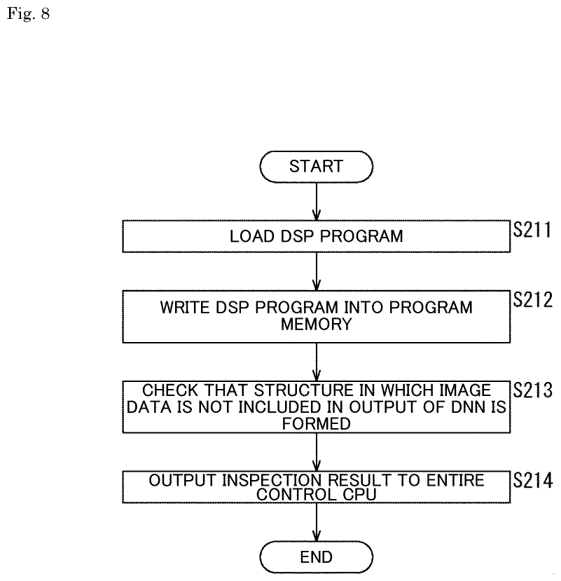

First, an operation (a checking process) of the network inspection block 219 will be described with reference to the flowchart illustrated in FIG. 8.

In Step S211, the network inspection block 219 loads the DSP program from the outside through the input I/F 218.

In Step S212, the network inspection block 219 writes the DSP program loaded from the outside into the program memory 215.

In Step S213, the network inspection block 219 checks (inspects) that a network structure in which image data is not included in the output of the DNN is formed for the DSP program written into the program memory 215.

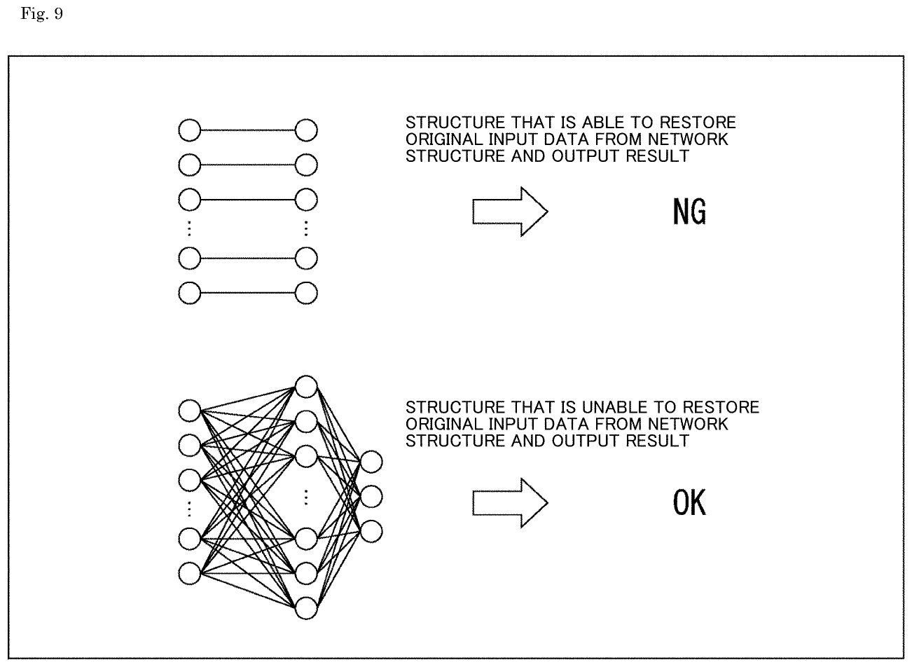

As illustrated in FIG. 9, for example, in a case in which the network structure of the DNN is a structure in which image data is output as it is or a structure in which original input data (image data) can be restored from a network structure and an output result, the network inspection block 219 determines that there is a problem (NG) in the network structure of this DNN. On the other hand, in a case in which the network structure of the DNN is a structure in which original input data (image data) cannot be restored from a network structure and an output result such as a structure having an irreversible activation function, a structure having a fully-coupled layer, or the like, the network inspection block 219 determines that there is no problem (OK) in the network structure of this DNN.

In addition, in a DSP program, after checking that the network structure is a network structure of the DNN in which image data is not output in advance, changes of other than weights (parameters) may be configured to be unchangeable by configuring the network structure of the DNN as a ROM. In addition, by configuring the weights (parameters) as a ROM as well, only a fixed process may be performed.

In Step S214, the network inspection block 219 outputs an inspection result representing whether or not there is a problem in the network structure of the DNN to the entire control CPU 220.

### (Operation of Entire Imaging Apparatus)

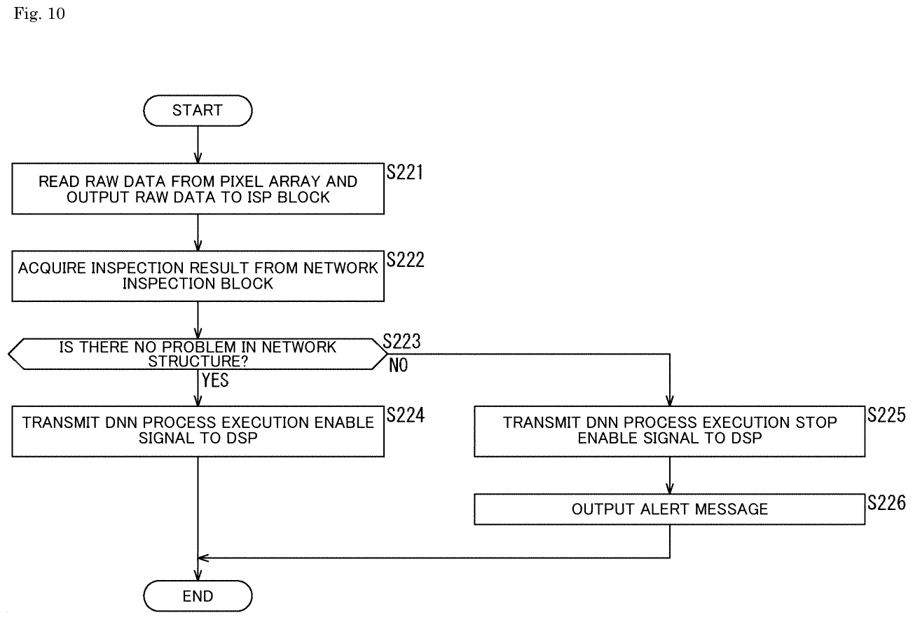

Next, the operation of the entire imaging apparatus 200 will be described with reference to a flowchart illustrated in FIG. 10. The process of FIG. 10, for example, starts in accordance with reception of instruction of start of imaging for the imaging apparatus 200 or the like.

In Step S221, the column ADC 212 reads raw data from the pixel array 211 and outputs the raw data to the ISP block 213. The ISP block 213 performs various kinds of image processing on the raw data from the column ADC 212.

In Step S222, the entire control CPU 220 acquires an inspection result from the network inspection block 219.

In Step S223, the entire control CPU 220 determines whether or not there is a problem in the network structure of the DNN on the basis of the inspection result from the network inspection block 219. In other words, it is determined whether or not a user can acquire image data from the output of the DSP 214.

In a case in which it is determined that there is no problem in the network structure of the DNN in Step S223, in other words, in a case in which it is determined that a user cannot acquire image data from the output of the DSP 214, the process proceeds to Step S224. In Step S224, the entire control CPU 220 transmits an enable signal (ON) for execution of a DNN process (recognition processing using a DNN) to the DSP 214. In accordance with this, the DSP 214 starts execution of recognition processing for image data after image processing using the ISP block 213.

On the other hand, in a case in which it is determined that there is a problem in the network structure of the DNN in Step S223, in other words, in a case in which it is determined that a user can acquire image data from the output of the DSP 214, the process proceeds to Step S225. In Step S225, the entire control CPU 220 transmits a DNN process execution stop enable signal (OFF) to the DSP 214. The DSP 214 stops the execution of recognition processing for image data after image processing using the ISP block 213.

In addition, in Step S226, the entire control CPU 220 generates alert information and supplies the alert information to the output I/F 217, whereby the output I/F 217 outputs an alert message.

In accordance with the configuration and the process described above, it is checked that image data is not included in the output of the DSP 214, and, in a case in which image data is included in the output of the DSP 214, execution of the recognition processing stops. As a result, image data is not output to the outside, and the risk of privacy invasion can be reduced.

### Second Configuration Example

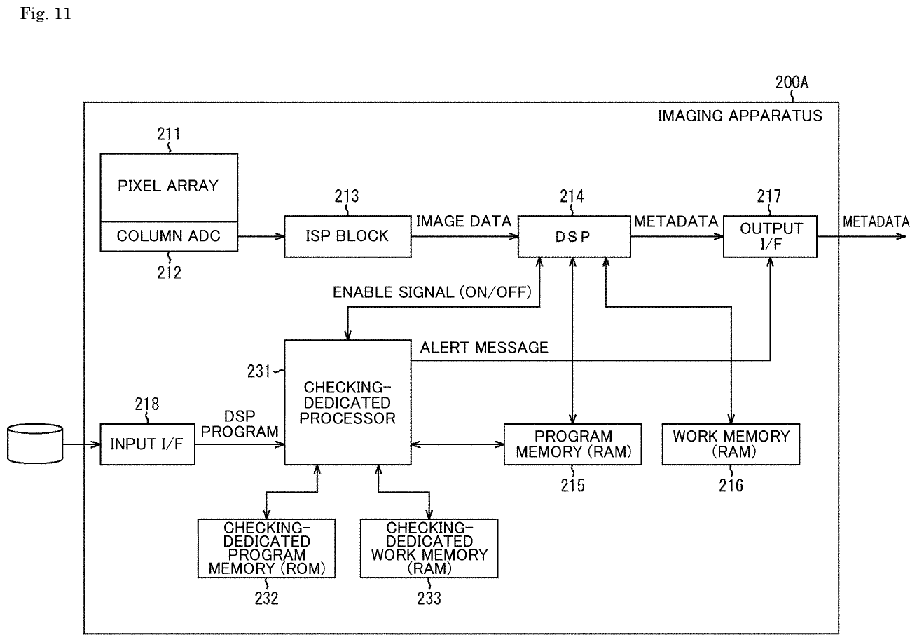

FIG. 11 is a block diagram illustrating a second configuration example of an imaging apparatus according to the second embodiment.

In the imaging apparatus 200A illustrated in FIG. 11, the same reference signs will be assigned to components similar to the components included in the imaging apparatus 200 illustrated in FIG. 7, and description thereof will be omitted.

In other words, the imaging apparatus 200A illustrated in FIG. 11 includes a checking-dedicated processor 231, a checking dedicated program memory 232, and a checking-dedicated work memory 233 in place of the network inspection block 219 and the entire control CPU 220, which is different from the imaging apparatus 200 illustrated in FIG. 7.

The checking-dedicated processor 231, for example, is configured using a dedicated CPU and executes a checking process of checking that image data is not included in the output of the DSP 214 before recognition processing using the DSP 214. In addition to the function of a checking processing unit executing a checking process, the checking-dedicated processor 231 may further have a function similar to that of the entire control CPU 220 illustrated in FIG. 7.

In the checking-dedicated program memory 232, a program used for causing the checking-dedicated processor 231 to execute a checking process is stored. The checking-dedicated program memory 232 is configured using a ROM and causes a program for executing a checking process to be un-rewritable.

The checking-dedicated work memory 233 is configured using a RAM, and a program (DSP program) for executing recognition processing, which is loaded from the outside, is written in the checking-dedicated work memory 233.

### (Operation of Checking-Dedicated Processor)

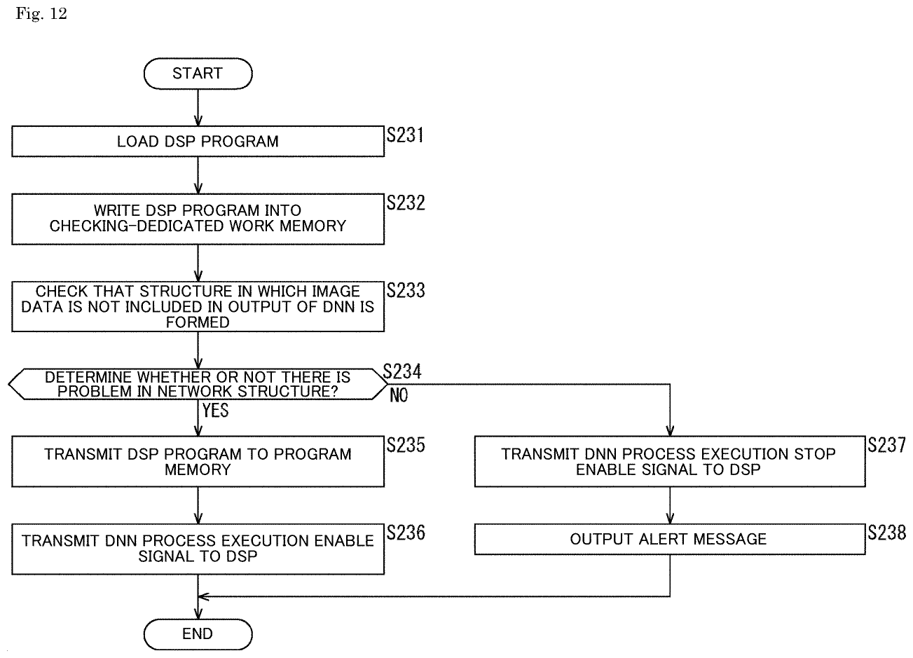

An operation of the checking-dedicated processor 231 will be described with reference to a flowchart illustrated in FIG. 12.

In Step S231, the checking-dedicated processor 231 loads a DSP program from the outside through the input I/F 218.

In Step S232, the checking-dedicated processor 231 writes the DSP program loaded from the outside into the checking-dedicated work memory 233.

In Step S233, the checking-dedicated processor 231 checks (inspects) that a network structure in which image data is not included in the output of a DNN is formed for a DSP program written in the checking-dedicated work memory 233.

In Step S234, the checking-dedicated processor 231 determines whether or not there is a problem in the network structure of the DNN.

In a case in which it is determined that there is no problem in the network structure of the DNN in Step S234, the process proceeds to Step S235, and the checking-dedicated processor 231 transmits a DSP program written in the checking-dedicated work memory 233 to the program memory 215.

In Step S235, the checking-dedicated processor 231 transmits a DNN process (recognition processing using a DNN) execution enable signal (ON) to the DSP 214. In accordance with this, the DSP 214 starts execution of recognition processing for image data after image processing using the ISP block 213.

On the other hand, in a case in which it is determined that there is a problem in the network structure of the DNN in Step S234, the process proceeds to Step S237, and the checking-dedicated processor 231 transmits a DNN process execution stop enable signal (OFF) to the DSP 214. The DSP 214 stops the execution of the recognition processing on image data after image processing using the ISP block 213.

In addition, in Step S238, the checking-dedicated processor 231 generates alert information and supplies the alert information to the output I/F 217, and thus, the output I/F 217 outputs an alert message.

According to the configuration and the process described above, it is checked that image data is not included in the output of the DSP 214, and, in a case in which image data is included in the output of the DSP 214, the execution of the recognition processing is stopped. As a result, image data is not output to the outside, and the risk of privacy invasion can be reduced.

In addition, since the program used for the execution of a checking process is configured to be un-rewritable, a structure in which image data is not output from the DSP 214 can be reliably realized.

### Third Configuration Example

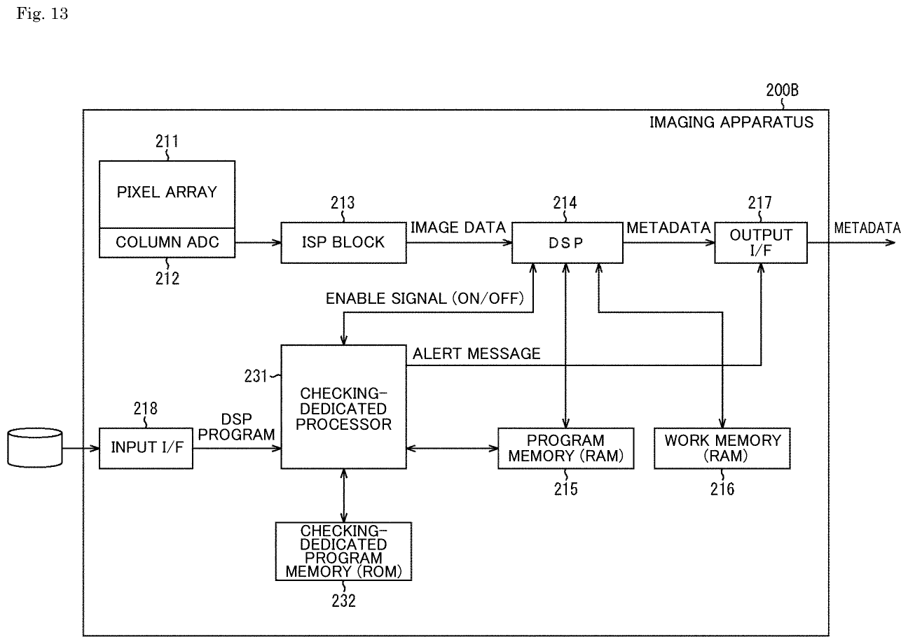

FIG. 13 is a block diagram illustrating a third configuration example of an imaging apparatus according to the second embodiment.

In the imaging apparatus 200B illustrated in FIG. 13, the same reference signs will be assigned to components similar to the components included in the imaging apparatus 200A illustrated in FIG. 11, and description thereof will be omitted.

In other words, the imaging apparatus 200B illustrated in FIG. 13 does not have the checking-dedicated work memory 233, which is different from the imaging apparatus 200A illustrated in FIG. 11.

### (Operation of Checking-Dedicated Processor)

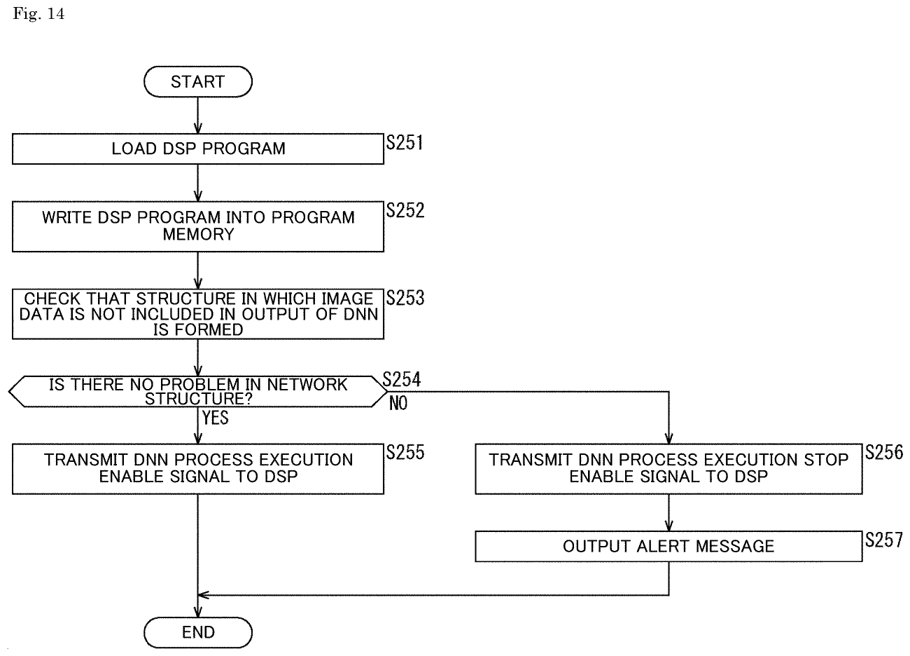

An operation of the checking-dedicated processor 231 will be described with reference to a flowchart illustrated in FIG. 14.

In Step S251, the checking-dedicated processor 251 loads a DSP program from the outside through the input I/F 218.

In Step S252, the checking-dedicated processor 231 directly writes the DSP program loaded from the outside into the program memory 215.

In Step S253, the checking-dedicated processor 231 checks (inspects) that a network structure in which image data is not included in the output of a DNN is formed for a DSP program written in the program memory 215.

In Step S254, the checking-dedicated processor 231 determines whether or not there is a problem in the network structure of the DNN.

In a case in which it is determined that there is no problem in the network structure of the DNN in Step S254, the process proceeds to Step S255, and the checking-dedicated processor 231 transmits a DNN process (recognition processing using a DNN) execution enable signal (ON) to the DSP 214. In accordance with this, the DSP 214 starts execution of recognition processing for image data after image processing using the ISP block 213.

On the other hand, in a case in which it is determined that there is a problem in the network structure of the DNN in Step S254, the process proceeds to Step S256, and the checking-dedicated processor 231 transmits a DNN process execution stop enable signal (OFF) to the DSP 214. The DSP 214 stops the execution of the recognition processing on image data after image processing using the ISP block 213.

In addition, in Step S257, the checking-dedicated processor 231 generates alert information and supplies the alert information to the output I/F 217, and thus, the output I/F 217 outputs an alert message.

According to the configuration and the process described above, it is checked that image data is not included in the output of the DSP 214, and, in a case in which image data is included in the output of the DSP 214, the execution of the recognition processing is stopped. As a result, image data is not output to the outside, and the risk of privacy invasion can be reduced.

In addition, since the program used for the execution of a checking process is configured to be un-rewritable, a structure in which image data is not output from the DSP 214 can be reliably realized.

Furthermore, differently from the configuration of the imaging apparatus 200A illustrated in FIG. 11, a DSP program loaded from the outside is directly written into the program memory 215, and thus the network structure of the DNN can be checked without disposing the checking-dedicated work memory 233.

The imaging apparatus according to the second embodiment described above can be configured to be combined with the imaging apparatus according to the first embodiment. In other words, after it is checked that image data is not included in the output of the DSP 214, image data is deleted after recognition processing, and only metadata (a recognition result) can be configured to be output to the outside.

### 4. Application Example

Hereinafter, application examples of the technology according to the present disclosure will be described.

### (Monitoring Camera)

The technology according to the present disclosure can be applied to a monitoring camera used for watching over an elderly person or a person requiring care.

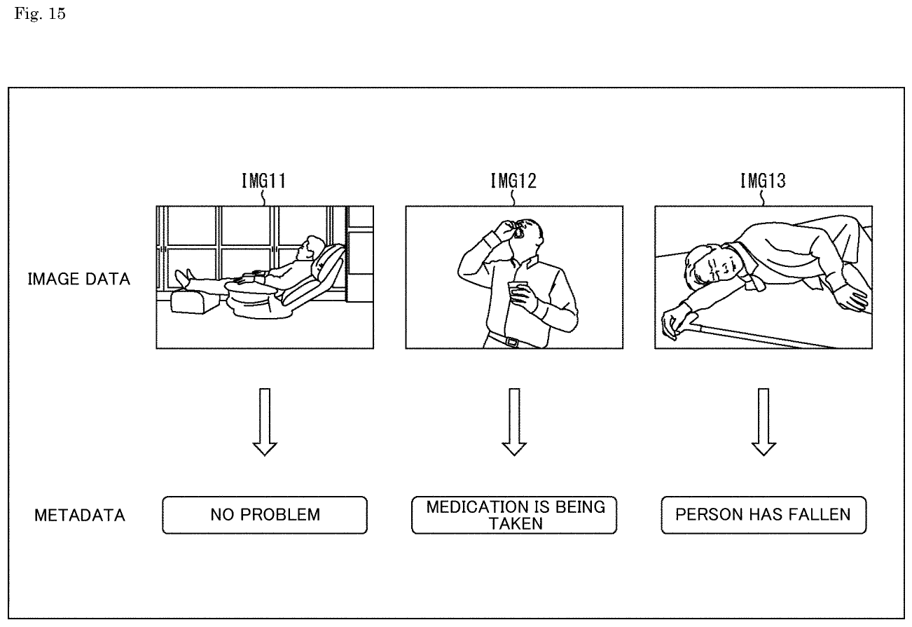

More specifically, as illustrated in FIG. 15, in a case in which a monitoring target appears to be resting quietly in image data IMG11, as a recognition result of recognition processing on the image data IMG11, metadata such as “No problem” is output. In addition, in a case in which a monitoring target appears to be taking medication in image data IMG12, as a recognition result of recognition processing on the image data IMG12, metadata such as “Medication is being taken” is output. Furthermore, in a case in which a monitoring target appears to have fallen in image data IMG13, as a recognition result of recognition processing on the image data IMG13, metadata such as “Person has fallen” is output.

In a monitoring camera in which a general image sensor is mounted, image data is output to the outside due to a certain reason, and thus there is a risk that an individual's face, daily activities, and the like may be spied on.

In contrast to this, according to the technology relating to the present disclosure, since image data is not output to the outside, the function of a monitoring camera can be accomplished while the privacy is protected without an individual's face, daily activities, and the like being spied on.

### (Consumer Behavior Analysis)

The technology relating to the present disclosure can be applied to a consumer behavior analysis in a commercial facility such as a shopping center or the like.

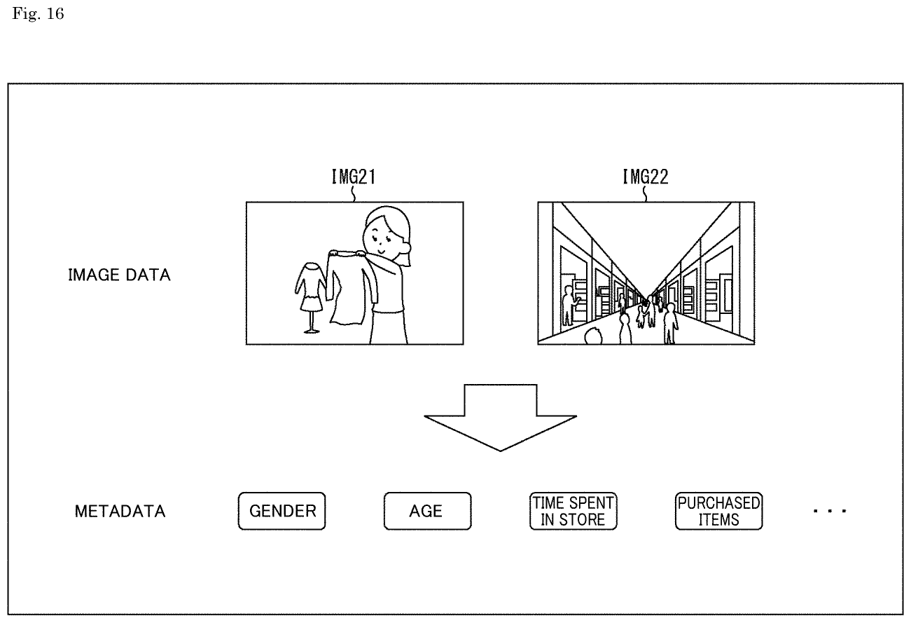

More specifically, as illustrated in FIG. 16, in a case in which a customer appears to be shopping in image data IMG21 and image data IMG22, as a recognition result of recognition processing on the image data IMG21 and IMG22, metadata representing “gender,” and “age,” of the customer, “time spent in the store,” “purchased items,” and the like is output.

In this way, according to the technology relating to the present disclosure, since image data is not output to the outside, only information such as “gender,” “age,” and the like that are useful for a consumer behavior analysis can be extracted in a form not constituting personal information.

In addition, in an imaging apparatus to which the technology relating to the present disclosure is applied, in addition to execution of recognition processing as signal processing of a DSP, other signal processing such as the fusion process and the self-position estimating process described above may be executed. Also in such a case, a structure in which image data is not output to the outside can be realized, and thus the risk of privacy invasion can be reduced.

The advantageous effects described herein are merely exemplary and are not limited, and other advantageous effects may be obtained.

Further, the embodiments to which the technology according to the present disclosure is applied are not limited to the above-described embodiments, and various changes can be made without departing from the gist of the technology according to the present disclosure.

Further, the present disclosure can be configured as follows.

(1)

An imaging apparatus including: an imaging unit, in which a plurality of pixels are two-dimensionally aligned, configured to capture an image; a signal processing unit configured to execute signal processing for image data based on an output of the imaging unit; and an output unit, which is not directly connected to the imaging unit, configured to be able to output only a signal processing result of the signal processing to the outside, wherein the signal processing unit deletes the image data after the signal processing.

(2)

The imaging apparatus described in (1), further including a first storage unit configured to be temporarily written data relating to the signal processing, wherein the signal processing unit deletes the image data written in the first storage unit for the signal processing after the signal processing.

(3)

The imaging apparatus described in (2), further including a second storage unit configured to be stored a program for executing the signal processing, wherein the second storage unit sets the program to be un-rewritable.

(4)

The imaging apparatus described in (3), in which the program causes the signal processing using a neural network to be executable.

(5)

The imaging apparatus described in any one of (1) to (4), in which the signal processing unit executes recognition processing for the image data as the signal processing and outputs metadata of the image data as a recognition result of the recognition processing.

(6)

The imaging apparatus described in any one of (1) to (5), in which the imaging unit and the signal processing unit are arranged inside of one chip.

(7)

The imaging apparatus described in (6), in which the chip includes a first substrate and a second substrate that are bonded to each other, in which the first substrate includes the imaging unit, and in which the second substrate includes the signal processing unit.

(8)

An imaging apparatus including: an imaging unit, in which a plurality of pixels are two-dimensionally aligned, configured to capture an image; a signal processing unit configured to execute signal processing for image data based on an output of the imaging unit; an output unit configured to be able to output a signal processing result of the signal processing to the outside; and a checking processing unit configured to execute a checking process of checking that the image data is not included in an output of the signal processing unit before the signal processing.

(9)

The imaging apparatus described in (8), in which the signal processing unit executes the signal processing in a case in which a user is determined to be unable to acquire the image data from the output of the signal processing unit.

(10)

The imaging apparatus described in (9), in which a first program used for executing the signal processing is loaded from the outside, and in which the checking processing unit executes the checking process for the first program.

(11)

The imaging apparatus described in (10), in which the first program causes the signal processing using a neural network to be executable, and in which the checking processing unit checks that a network structure of the neural network is a structure that is unable to output the image data.

(12)

The imaging apparatus described in (11), in which, in a case in which the network structure is a structure in which the image data is unable to be restored from the network structure and an output result, the checking processing unit instructs the signal processing unit to execute the signal processing.

(13)

The imaging apparatus described in any one of (8) to (12), further including a storage unit configured to be stored a second program used for executing the checking process, wherein the storage unit sets the second program to be un-rewritable.

(14)

The imaging apparatus described in any one of (8) to (13), in which, in a case in which it is determined that a user is able to acquire the image data from the output of the signal processing unit, the signal processing unit stops the execution of the signal processing.

(15)

The imaging apparatus described in (14), further including an alert generating unit configured to generate alert information in a case in which it is determined that the image data is included in the output of the signal processing unit.

(16)

The imaging apparatus described in any one of (8) to (15), in which the output unit is not directly connected to the imaging unit.

(17)

The imaging apparatus described in (8) to (16), in which the imaging unit, the signal processing unit, and the checking processing unit are arranged inside of one chip.

(18)

The imaging apparatus described in (17), in which the chip includes a first substrate and a second substrate that are bonded to each other, in which the first substrate includes the imaging unit, and in which the second substrate includes the signal processing unit and the checking processing unit.

(19)

A data output method including deleting image data after signal processing using an imaging apparatus including: an imaging unit, in which a plurality of pixels are two-dimensionally aligned, configured to capture an image; a signal processing unit configured to execute the signal processing for the image data based on an output of the imaging unit; and an output unit, which is not directly connected to the imaging unit, configured to be able to output only a signal processing result of the signal processing to the outside.

(20)

The data output method described in (19), in which a checking process of checking that the image data is not included in an output of the signal processing unit is executed before the signal processing.

### REFERENCE SIGNS LIST

1 Imaging apparatus
10 Imaging block
11 Pixel array
12 Column ADC
13 Control unit
20 Signal processing block
21 ISP unit
22 DSP
51 CPU
52 External I/F
100 Imaging apparatus
111 Pixel array
112 Column ADC
113 ISP block
114 DSP
115 Program memory
116 Work memory
117 Data transmission block
118 Output I/F
200, 200A, 200B Imaging apparatus
211 Pixel array
212 Column ADC
213 ISP block
214 DSP
215 Program memory
216 Work memory
217 Output I/F
218 Input I/F
219 Network inspection block
220 Entire control CPU
231 Checking-dedicated processor
232 Checking-dedicated program memory
233 Checking-dedicated work memory

1. An imaging apparatus comprising:
an imaging unit, in which a plurality of pixels is two-dimensionally aligned, configured to capture an image;
a signal processing unit configured to execute signal processing for image data based on an output of the imaging unit; and
an output unit, which is not directly connected to the imaging unit, configured to be able to output only a signal processing result of the signal processing to the outside,
wherein the signal processing unit deletes the image data after the signal processing.

2. The imaging apparatus according to claim 1, further comprising a first storage unit configured to be temporarily written data relating to the signal processing, wherein the signal processing unit deletes the image data written in the first storage unit for the signal processing after the signal processing.

3. The imaging apparatus according to claim 2, further comprising a second storage unit configured to be stored a program for executing the signal processing, wherein the second storage unit sets the program to be un-rewritable.

4. The imaging apparatus according to claim 3, wherein the program causes the signal processing using a neural network to be executable.

5. The imaging apparatus according to claim 1, wherein the signal processing unit executes recognition processing for the image data as the signal processing and outputs metadata of the image data as a recognition result of the recognition processing.

6. The imaging apparatus according to claim 1, wherein the imaging unit and the signal processing unit are arranged inside of one chip.

7. The imaging apparatus according to claim 6,
wherein the chip includes a first substrate and a second substrate that are bonded to each other,
wherein the first substrate includes the imaging unit, and
wherein the second substrate includes the signal processing unit.

8. An imaging apparatus comprising:
an imaging unit, in which a plurality of pixels is two-dimensionally aligned, configured to capture an image;
a signal processing unit configured to execute signal processing for image data based on an output of the imaging unit;
an output unit configured to be able to output a signal processing result of the signal processing to the outside; and
a checking processing unit configured to execute a checking process of checking that the image data is not included in an output of the signal processing unit before the signal processing.

9. The imaging apparatus according to claim 8, wherein the signal processing unit executes the signal processing in a case in which a user is determined to be unable to acquire the image data from the output of the signal processing unit.

10. The imaging apparatus according to claim 9,
wherein a first program used for executing the signal processing is loaded from the outside, and
wherein the checking processing unit executes the checking process for the first program.

11. The imaging apparatus according to claim 10,
wherein the first program causes the signal processing using a neural network to be executable, and
wherein the checking processing unit checks that a network structure of the neural network is a structure that is unable to output the image data.

12. The imaging apparatus according to claim 11, wherein, in a case in which the network structure is a structure in which the image data is unable to be restored from the network structure and an output result, the checking processing unit instructs the signal processing unit to execute the signal processing.

13. The imaging apparatus according to claim 8, further comprising a storage unit configured to be stored a second program used for executing the checking process, wherein the storage unit sets the second program to be un-rewritable.

14. The imaging apparatus according to claim 8, wherein, in a case in which it is determined that a user is able to acquire the image data from the output of the signal processing unit, the signal processing unit stops the execution of the signal processing.

15. The imaging apparatus according to claim 14, further comprising an alert generating unit configured to generate alert information in a case in which it is determined that the image data is included in the output of the signal processing unit.

16. The imaging apparatus according to claim 8, wherein the output unit is not directly connected to the imaging unit.

17. The imaging apparatus according to claim 8, wherein the imaging unit, the signal processing unit, and the checking processing unit are arranged inside of one chip.

18. The imaging apparatus according to claim 17,
wherein the chip includes a first substrate and a second substrate that are bonded to each other,
wherein the first substrate includes the imaging unit, and
wherein the second substrate includes the signal processing unit and the checking processing unit.

19. A data output method comprising deleting image data after signal processing using an imaging apparatus including:
an imaging unit, in which a plurality of pixels is two-dimensionally aligned, configured to capture an image;
a signal processing unit configured to execute the signal processing for the image data based on an output of the imaging unit; and
an output unit, which is not directly connected to the imaging unit, configured to be able to output only a signal processing result of the signal processing to the outside.

20. The data output method according to claim 19, wherein a checking process of checking that the image data is not included in an output of the signal processing unit is executed before the signal processing.
